(19) United States
(12) Patent Application Publication
(10) Pub. No.: US 2020/0147940 A1
(43) Pub. Date: May 14, 2020

(54) BIODEGRADABLE PLIABLE IMAGE-LADEN POLY-PLASTIC FOAM

(71) Applicant: Craig Miller, San Clemente, CA (US)

(72) Inventor: Craig Miller, San Clemente, CA (US)

(21) Appl. No.: 16/185,999

(22) Filed: Nov. 9, 2018

(51) Int. Cl. B32B 27/06; B32B 7/12; B32B 27/32; B32B 27/30; B32B 5/18

(52) U.S. Cl. CPC B32B 27/065; B32B 7/12; B32B 27/32; B32B 27/304; B29C 45/16; B32B 2307/7163; B32B 2307/75; B32B 2266/0278; B32B 5/18

(57) ABSTRACT

The present invention provides an image-laden material and method that overcomes the disadvantages described above while enabling the adherence of a uniform high definition print to a biodegradable pliable polyurethane foam. More specifically, an image-laden material with a desired imprinted image and which is made of an image-laden capable polyethylene film, adhesive, and a polyvinyl chloride (PVC) protection layer is provided to a PE mold to form a shape similarly to the desired shape of the thermoplastic material. The shaped image-laden material is then transferred to a second PU mold for forming the desired image-laden shape of a biodegradable polyurethane foam material where polyurethane foam is premixed with a biodegradable agent to initiate a foaming process and added to the mold. During the foaming process the polyurethane foam material increases in mass while forming an outer adhesive surface that forms a strong cohesion with the polyethylene film of the image-laden material.

### BACKGROUND OF INVENTION

The present invention relates to the practice of producing a biodegradable pliable toy using a mold for forming the image-laden material and a mold for forming a pliable substrate whereby the image-laden material adheres to the pliable substrate during the foaming process.

It is commonly known in the molding industry how polyurethane foam is made to desired densities, strengths, and pliability, (America Chemistry Counsel et al. How Polyurethane is Made https://polyurethane.americanchemistry.com/Introduction-to-Polyurethanes) Molding of polyurethane foam is well known in the art whereby a liquid form of polyurethane is placed in a mold. The mold can be of a desired shape and when injecting the mold with thermoplastic material the thermoplastic will take the form of the mold. When completed the thermoplastic material is extracted and retains the shape of the mold. Although this process enables one to produce in high volumes, make many types of shapes and forms of thermoplastic material the environmental impact the products have has not been assessed. The problem is exacerbated when considering the number of factories that are mass producing polyurethane foam toys that are supplied worldwide.

### SUMMARY OF THE INVENTION

The present invention provides an image-laden material and method that overcomes the disadvantages described above while enabling the adherence of a uniform high definition print to a pliable polyurethane foam. More specifically, an image-laden material with a desired imprinted image and which is made of an image-laden capable polyethylene film, adhesive, and a polyvinyl chloride (PVC) protection layer is provided to a PE mold to form a shape similarly to the desired shape of the thermoplastic material. The shaped image-laden material is then transferred to a second PU mold for forming the desired image-laden shape of the polyurethane elastomer foam material. The polyurethane elastomer foam material is formed in reaction of mixing the isocyanate, polyol, and a biodegradable additive thereby creating a foaming process and that is added to the mold. During the foaming process in the mold the polyurethane foam material increases in mass forming an outer adhesive surface that creates a strong cohesion with the polyethylene film of the image-laden material. Additionally, the biodegradable additive attracts microbes to secrete acids that consumes the foam, turning the foam into Ch4, Co2, biomass, and water.

Various additional objectives, advantages, and features of the invention will be appreciated from a review of the following detailed description of the illustrative embodiments taken in conjunction with the accompanying drawings.

### BRIEF DESCRIPTION OF THE DRAWINGS

In the accompanying drawings that form a part of the specification and that are to be read in conjunction therewith, and in which like reference numerals are used to indicate like parts in the various views:

Various additional objectives, advantages, and features of the invention will be appreciated from a review of the following detailed description of the illustrative embodiments taken in conjunction with the accompanying drawings.

FIG. 1 is an illustration of the image-laden material of the present invention;

FIG. 2 is an illustration of the PE mold with image-laden polyethylene film of the present invention;

FIG. 3 is an illustration of the image-laden poly-plastic sheet and a polyurethane foam in a PU mold of the present invention;

FIG. 4 is an illustration of the image-laden poly-plastic sheet and an expanded polyurethane foam in a PU mold of the present invention;

FIG. 5 is an illustration of the of the formed pliable image laden poly-plastic object;

FIG. 6 is an illustration of the of steps to form an image laden thermoplastic object

### DETAILED DESCRIPTION OF THE DRAWINGS

The following detailed description is merely exemplary in nature and is not intended to limit the invention or the application and uses of the invention. Furthermore, there is no intention to be bound by any expressed or implied theory presented in the preceding technical field, background, summary or the following detailed description.

A portion of the invention may be described herein in terms of steps. It should be appreciated that such steps may be realized by alternative order.

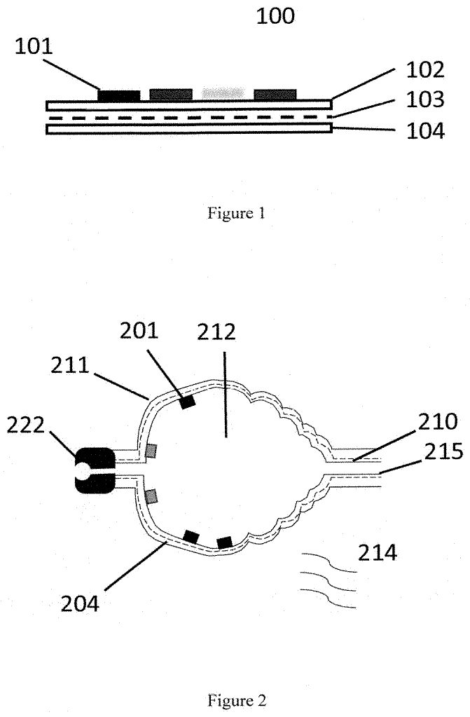

The overall purpose of the image laden material is to enable the adherence of a uniform high definition print to a pliable polyurethane foam. More specifically, an image is applied to a polyethylene film via an imaging process, similar to the image process known in the art as the gravure printing method whereby a color image using ink at a resolution of 200 lines per inch is transferred to the polyethylene film leaving an image-laden polyethylene film. 102 of FIG. 1. An adhesion layer 103 is then applied to the opposing side of the image-laden polyethylene film using a roller, not shown. A polyvinyl chloride layer (PVC) 104 layer is used to form a shape that is similar to the desired shape of the pliable substrate when molded, not shown, and is applied to the adhesion layer 102. The combined image laden polyethylene film 102, adhesion layer 103, and the PVC are inserted into a PE mold 210 as represented in FIG. 2 such that the image is facing towards the PE mold inner cavity 212 and the PVC layer is adjacent to the PE Mold wall 211 of the PE mold 210. The PE Mold 210 is made to of a clam shell design with a mold hinge 222 enabling two halves of the mold to open. Applying a combination of heat 214 (30-40 degrees C.) and a vacuum or air pressure to the PE Mold 210 binds and molds to form the image laden polyethylene film 102, adhesion layer 103, and the PVC to form an image-laden poly-plastic 215 in a substantially similar form of the PE Mold 210. Alternative, to the vacuum or air pressure application a stamped molding process can be used.

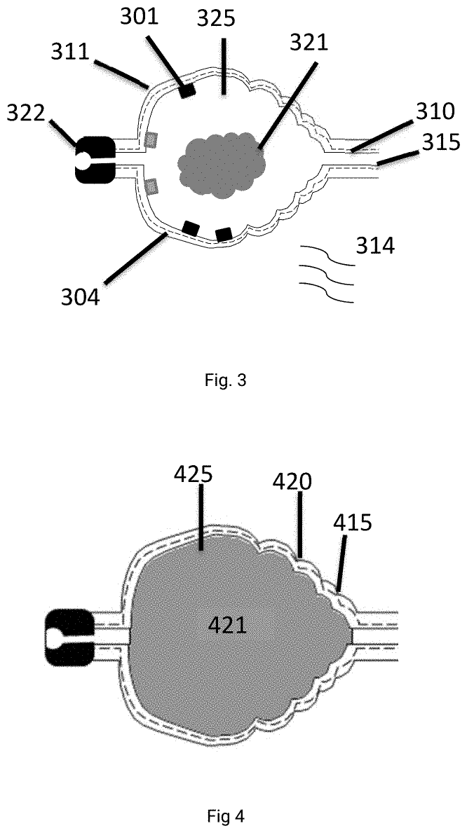

As represented in FIG. 3, once cooled, the image-laden poly-plastic sheet 315 is placed into a PU mold 320 which is of a a clam shell design with a mold hinge 322, enabling two halves of the mold to open reveling an PE mold inner cavity 325. The image-laden poly-plastic sheet 315 is placed within the mold with the image 301 side off the image-laden poly-plastic facing inward towards the PE mold inner cavity 325 while aligning the form of image-laden poly-plastic sheet 315 with the form of the PE mold 320. Polyurethane mix 321 is premixed whereby the liquid polyurethane is mixed with an accelerant, and a biodegradable agent to form the polyurethane mix 321 which also initiates the foaming process. The polyurethane mix 321 is then added to the PU mold 320 and the PU mold 320 is closed.

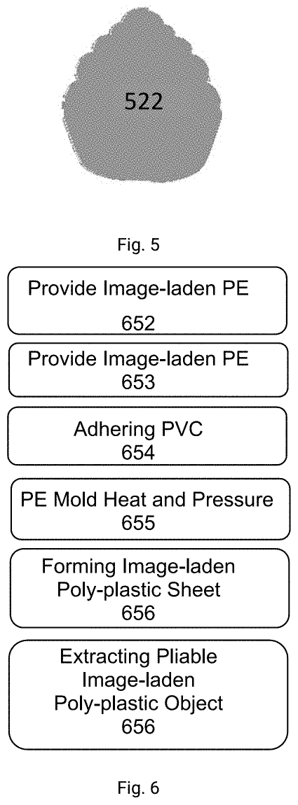

The polyurethane mix increases in mass to form a polyurethane foam 420 with an outer adhesive surface. The outer adhesion surface contacts the formed image-laden poly-plastic sheet 415 and forms a strong cohesive bond with the formed image-laden poly plastic sheet 415. Additionally, the expanding polyurethane foam 420 forms the shape of the PU Mold 425 by expanding until the volume of the PU cavity 435 is filled. The expanded polyurethane foam 420 is then removed from the PU mold 420, forming a pliable image laden poly-plastic foam 522 as represented in FIG. 5, whereby, as known in the art, the pliability and flexibility of the poly-plastic foam 522 is predetermined by the type of polyurethane and additive is chosen.

The poly-plastic foam 522, that includes the biodegradable agent such as BioSphere 302 Additive offered by Biosphere Plastics LLP at the website located at www.biosphereplastic.com/biodegradable-plastic-additive, increases the hydrophilic content within the poly-plastic foam thereby enabling an expedited biodegradation. The increased hydrophilic content enables the hydrolysis, the beginning of the anaerobic digestion which is the chemical breakdown of a compound due to reaction with water. Hydrolysis process yields the second phase, the acidogenesis phase, of the anaerobic digestion process which is the process where simple monomers are converted into volatile fatty acids. The fatty acids yield the third phase of the process, which is the acetogenesis phase where the fatty acids are converted into acetic acid, carbon dioxide, and hydrogen. Finally, the acetates of the acetogenesis phase are converted into methane and carbon dioxide, while hydrogen is consumed in the final methanogenesis phase of the anaerobic digestion process. Adding the biodegradable agent to the polyurethane mix at a ratio of one percent (1%) by volume yields a full breakdown of the pliable image-laden poly-plastic foam in two years.

The steps of producing a pliable image-laden poly-plastic foam is further described in FIG. 6 whereby an imaged-laden polyethylene film is provided 650 whereby a color image is printed on polyurethane film. Applying an adhesive layer to the non-image laden side of the polyethylene film is the next step 653. Adhering a PVC sheet 654, adjacent to the adhesive layer is the next step in the process. Forming an image laden poly-plastic sheet 655 conforming to the form of the PE mold by applying heat and pressure to the PE mold 667 is steps in the process. Transferring the formed poly-plastic sheet to a PU mold 656 and introducing a polyurethane mix 657 into the PU mold such that the polyurethane mix expands to fill the cavity of the PU mold is the next steps in the process. The final step in the process is to extract the pliable image-laden poly-plastic object from the PU mold.

What is claimed is:

1. An image-laden poly-plastic sheet for a biodegradable pliable substrate, consisting of:
a polyethylene film, for holding an image;
an adhesion layer, applied to the polyethylene film;
a polyvinyl chloride layer, to holding a shape;
a biodegradable pliable substrate; and
whereby the polyethylene film, adhesion layer, and polyvinyl chloride layer, are combined using heat and pressure to form an image-laden poly-plastic formed sheet.

2. An image-laden poly-plastic sheet for a biodegradable pliable substrate of claim 1, wherein the heat and pressure to form an image image-laden poly-plastic formed sheet is created by a mold.

3. An image-laden poly-plastic sheet for a biodegradable pliable substrate of claim 1, wherein the heat applied to form an image-laden poly-plastic formed sheet is between 250° F. to 280° F.

4. An image-laden poly-plastic sheet for a biodegradable pliable substrate of claim 1, wherein the heat applied to form an image-laden poly-plastic formed sheet is 265° F.

5. An image -laden biodegradable pliable substrate, consisting of:
an image-laden poly-plastic formed sheet;
a polyurethane mix; and
wherein the image-laden poly-plastic formed sheet and the polyurethane mix are combined in a mold to form an image-laden biodegradable pliable substrate.

6. An image-laden poly-plastic sheet for a biodegradable pliable substrate of claim 5, wherein the heat and pressure to form an image image-laden poly-plastic formed sheet is created by a mold.

7. An image-laden poly-plastic sheet for a biodegradable pliable substrate of claim 5, wherein the pressure to form an image image-laden poly-plastic formed sheet is created by a vacuum.

8. A method of forming an image-laden poly-plastic sheet for a biodegradable pliable substrate, the method comprising:
(A) providing an image-laden poly-plastic sheet for a pliable substrate, the image-laden poly-plastic sheet comprising:
(i) a polyethene film, for holding an image;
(ii) an adhesion layer, applied to the polyethene film;
(iii)a polyvinyl chloride layer, to holding a shape;
(B) forming the image-laden poly-plastic sheet into a shape, using a PE mold;
(C) transferring the formed image-laden poly-plastic sheet into a PU mold;
(D) adding biodegradable polyurethane mix to the PU mold; and
(E) extracting a pliable image laden biodegradable poly-plastic foam from the PU mold.

9. A method of forming an image-laden biodegradable poly-plastic sheet for a pliable substrate, the method comprising:
(A) providing an image-laden poly-plastic sheet for a pliable substrate,
(B) forming the image-laden poly-plastic sheet into a shape, using a PE mold;
(C) transferring the formed image-laden poly-plastic sheet into a PU mold;
(D) adding biodegradable polyurethane mix to the PU mold; and
extracting a pliable image laden poly-plastic foam from the PU mold.
